(19) United States
(12) Patent Application Publication
(10) Pub. No.: US 2018/0089608 A1
(43) Pub. Date: Mar. 29, 2018

(54) SYSTEMS AND METHODS FOR MANAGING DELIVERY ROUTES

(71) Applicant: AMAZON TECHNOLOGIES, INC., Reno, NV (US)

(72) Inventors: John Christopher O'Hare, Seattle, WA (US); Juqi Liu, Seattle, WA (US)

(21) Appl. No.: 14/299,457

(22) Filed: Jun. 9, 2014

(51) Int. Cl. G06Q 10/06; G06Q 10/08

(52) U.S. Cl. CPC G06Q 10/063112; G06Q 10/08355

(57) ABSTRACT

According to one or more embodiments of the disclosure, a method is provided. The method may include periodically determining one or more delivery routes associated with a delivery station. The method may also include identifying one or more delivery drivers to be assigned to the one or more delivery routes. Further, the method may include determining, based at least in part on location history data, route location data and efficiency data of delivery drivers, respective estimated route completion times associated with the one or more delivery drivers for the one or more delivery routes. The method may also include generating a routing assignment associated with the one or more delivery drivers and the one or more delivery routes.

Currently, with respect to managing delivery routes for a delivery station, drivers may be assigned static delivery territories. To this end, any parcels associated with a delivery location within a static territory of a driver may be added to the driver's route. Furthermore, routing assignment schedules may be manually determined by delivery station employees and/or other persons. Such routing assignment schedules may be relatively inefficient with respect to route completion times of the drivers and other aspects of route determination.

### BRIEF DESCRIPTION OF THE DRAWINGS

FIG. 1 illustrates a system for managing delivery routes in accordance with one or more embodiments of the disclosure.

FIG. 2 illustrates a system for managing delivery routes in accordance with one or more embodiments of the disclosure.

FIG. 3 illustrates a block diagram of a data flow for managing delivery routes in accordance with one or more embodiments of the disclosure.

FIG. 4 illustrates a flow diagram for managing delivery routes in accordance with one or more embodiments of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Described herein are systems and methods for managing delivery routes. Broadly, the systems and methods described herein may include a service provider server that determines one or more delivery routes. In some embodiments, the delivery routes may be determined for a day or any other time period (e.g., monthly, weekly, daily, hourly, based upon shifts, etc.) for a delivery station. The delivery station may be a last station from which parcel may be delivered to intended recipients. In order to determine the delivery routes for the delivery station for a particular day, the service provider servers may be configured to determine delivery demand information for that day. For instance, the delivery demand information may include information associated with a number of parcels to be delivered from the station for the day.

Upon determining the delivery routes, the service provider server may be configured to identify one or more drivers to whom to assign the delivery routes. According to one or more embodiments, in order to facilitate the assignments, the service provider server may be configured to determine location history data associated with the drivers. Location history data may indicate, for respective drivers, past delivery locations visited by the respective drivers on past delivery routes. In certain implementations, the past delivery locations may be associated with postal codes although other geographic information are also possible. The service provider server may also be configured to determine routing location data associated with the delivery routes. For instance, the service provider server may determine locations (e.g., postal codes) that may be covered by the respective routes.

As such, based at least in part on the location history data associated with the drivers and the route location data associated with the delivery routes, the service provider server may determine respective route completion times for the drivers with respect to the delivery routes. For instance, in certain implementations, the service provider server may estimate and/or calculate, for each driver, a route completion time for each driver to complete each delivery route. Such calculations may depend in part on the past delivery locations of the drivers. For example, if a driver has previously driven to and/or visited a past delivery location, the service provider server may estimate, for the driver, a faster route completion time for a delivery route covering the past delivery location than for a delivery route that does not cover the past delivery location. Thus, calculation of a driver's route completion time for a delivery route may be affected by whether the driver has previously driven to and/or visited a delivery location covered by the delivery route. In other words, the service provider server may determine that a driver is more likely to complete a route faster if he has previously driven to and/or visited a delivery location covered by the route.

Additionally, calculations of a route completion time for a driver and a route may also be based at least in part on how recently the driver has visited a past delivery location. As such, the more recent a driver has driven and/or visited a past delivery location covered by a route, the faster the driver's calculated route completion time for the route.

According to one or more other embodiments, the service provider server may also be configured to determine efficiency data associated with the identified drivers. In certain cases, the service provider server may also assign routes based at least in part on the efficiency data, in order to train new drivers and/or drivers unfamiliar with certain delivery locations. For instance, if the service provider server identifies a driver as approximately 75% efficient based upon his/her associated efficiency data, the service provider server may be configured to search for a route that is associated with approximately 75% of the work of a typical 100% route that a driver having an efficiency of 100% can complete in the allotted time.

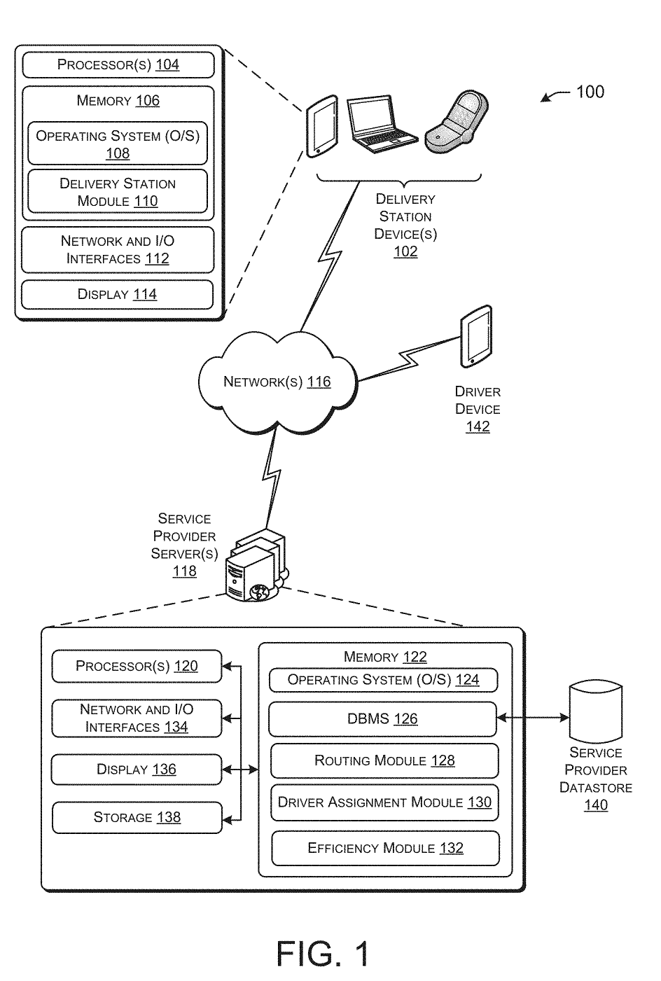

With reference now to FIG. 1, a system 100 for managing delivery routes is shown according to one or more embodiments of the disclosure. The system 100 may include one or more delivery station device(s) 102. In general, the delivery station device 102 may refer to any type of electronic device, and more particularly, may refer to one or more of the following: a wireless communication device, a portable electronic device, a telephone (e.g., cellular phone, smart phone), a computer (e.g., laptop computer, tablet computer), a wearable computer device, a portable media player, a personal digital assistant (PDA), or any other electronic device having a networked capability. The delivery station device(s) 102 may include one or more computer processors 104, a memory 106 storing an operating system 108 and a delivery station module 110, network and I/O interfaces 112, and a display 114. In certain embodiments, the delivery station device(s) 102 may include one or more sensors capable of gathering information associated with a present environment of the delivery station device(s) 102, or similar hardware devices, such as a camera, microphone, antenna, or Global Positioning Satellite (GPS) device.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The delivery station device 102 may also include a chipset (not shown) for controlling communications between the one or more processors 104 and one or more of the other components of the delivery station device 102. In certain embodiments, the delivery station device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106 may comprise one or more computer-readable storage media (CRSM). In some embodiments, the memory 106 may include non-transitory media such as random access memory (RAM), flash RAM, magnetic media, optical media, solid state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system 108 that includes a plurality of computer-executable instructions that may be implemented by the computer processor to perform a variety of tasks to operate the interface(s) and any other hardware installed on the delivery station device 102. The operating system 108 may include any operating system now known or which may be developed in the future including, but not limited to, any server operating system, any mainframe operating system, or any other proprietary or freely available operating system. The memory 106 may also store content that may be displayed by the delivery station device 102 or transferred to other devices (e.g., headphones) to be displayed or played by the other devices. The memory 106 may also store content received from the other devices. The content from the other devices may be displayed, played, or used by the delivery station device 102 to perform any necessary tasks or operations that may be implemented by the computer processor or other components in the delivery station device 102.

Furthermore, the memory 106 may store a delivery station module 110 to facilitate the receipt of routes and routing assignment schedules for a delivery station. For instance, the delivery station module 110 may be configured to communicate with the service provider server(s) 118 to determine routes and routing assignment schedules for the delivery station. The delivery station module 110 may also include a user interface that may enable a user (e.g., such as a delivery station manager) to perform certain operations related to routing and routing assignment schedules. For example, the user interface may facilitate the selection and/or identification of available drivers for a particular day. The user interface may enable the user to affirmatively make a selection to request (e.g., from the service provider server(s) 118) the routes and routing assignment schedules for a particular day.

The network and I/O interfaces 112 may also comprise one or more communication interfaces or network interface devices to provide for the transfer of data between the delivery station device 102 and another device (e.g., network server) via a network (not shown). The communication interfaces may include, but are not limited to, personal area networks (PANs), wired local area networks (LANs), wireless local area networks (WLANs), wireless wide area networks (WWANs), and so forth. The delivery station device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published March 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the delivery station device 102 and another device such as an access point, a host computer, a server, a router, a reader device, and the like. The network may include, but is not limited to: the Internet, a private network, a virtual private network, a wireless wide area network, a local area network, a metropolitan area network, a telephone network, and so forth.

The display 114 may include, but is not limited to, a liquid crystal display, a light-emitted diode display, an E-Ink™ display as made by E Ink Corp. of Cambridge, Mass., or any other similar type of output device. The display 114 may be used to show content to a user in the form of text, images, or video. In certain instances, the display 114 may also operate as a touch screen display that may enable the user to initiate commands or operations by touching the screen using certain finger or hand gestures.

According to one or more embodiments, the delivery station device 102 may be in communication, via one or more networks 116, with one or more service provider server(s) 118. As used herein, unless otherwise specified, the term “server” may refer to any computing device having a networked connectivity and configured to provide one or more dedicated services to clients, such as a delivery station device 102. The services may include storage of data or any kind of data processing.

As such, the service provider server(s) 118 may include one or more processors 120 and a memory 122. The memory 122 may store an operating system 124, a database management system (DBMS) 126, a routing module 128, a driver assignment module 130, and an efficiency module 132. In addition, the service provider server(s) 118 may also include network and I/O interfaces 134, a display 136, and a storage 138. Furthermore the DBMS 126 may be in communication with a service provider datastore 140. While any of the above mentioned components in the delivery station device 102 and the service provider server(s) 118 may hereinafter be referred to in the singular, it will be appreciated that any future references to these components also contemplate them in a plurality.

The processors 120 may comprise one or more cores and may be configured to access and execute (at least in part) computer-readable instructions stored in the memory 122. The one or more computer processors 120 may include, without limitation (and similarly to the processors 104 in the delivery station device 102), a CPU, DSP, RISC, CISC, a microprocessor, a microcontroller, a field programmable gate array (FPGA), or any combination thereof. The service provider server 118 may also include a chipset (not shown) for controlling communications between the one or more processors 120 and one or more of the other components of the service provider server 118. In certain embodiments, the service provider server 118 may be based on an Intel® architecture or an ARM® architecture, and the processor(s) and chipset may be from a family of Intel® processors and chipsets. The one or more processors 120 may also include one or more application-specific integrated circuits (ASICs) or application-specific standard products (ASSPs) for handling specific data processing functions or tasks.

The memory 122 may comprise one or more computer-readable storage media (CRSM). Similar to the memory 106 in the delivery station device 102, the memory 122 may include non-transitory media such as RAM, flash RAM, magnetic media, optical media, solid state media, and so forth. The memory 122 may be volatile or non-volatile and may also be provided as a computer program product including a transitory machine-readable signal (in compressed or uncompressed form). Additionally, the memory 122 may store an operating system 124 that includes a plurality of computer-executable instructions that may be implemented by the computer processor to perform a variety of tasks to operate the interface(s) and any other hardware installed on the service provider server 118. The operating system 124 may include any operating system now known or which may be developed in the future including, but not limited to, any server operating system, any mainframe operating system, or any other proprietary or freely available operating system.

It should be appreciated that any data and/or computer-executable instructions stored in the memory 122 may be additionally, or alternatively, stored in the data storage 138 and/or in one or more other datastores. The DBMS 126 depicted as being loaded into the memory 122 may support functionality for accessing, retrieving, storing, and/or manipulating data stored in external datastore(s) (e.g., the service provider datastore(s) 140), data stored in the memory 122, and/or data stored in the data storage 138. For example, the DBMS 126 may be configured to retrieve user account data (e.g., information related to driver and/or driver identifiers) from service provider datastore(s) 140 responsive to receipt of the request from the service provider server 118. The DBMS 126 may use any of a variety of database models (e.g., relational model, object model, etc.) and may support any of a variety of query languages.

The network and I/O interfaces 134 may also comprise one or more communication interfaces or network interface devices to provide for the transfer of data between the service provider server 118 and another device (e.g., network server) via a network (not shown). The communication interfaces may include, but are not limited to, personal area networks (PANs), wired local area networks (LANs), wireless local area networks (WLANs), wireless wide area networks (WWANs), and so forth. As such, the service provider server 118 may be coupled to the network via a wired connection and/or a wireless connection. The communication interfaces may utilize acoustic, radio frequency, optical, or other signals to exchange data between the service provider server 118 and another device such as an access point, a host computer, a server, a router, a reader device, and the like. The network may include, but is not limited to, the Internet, a private network, a virtual private network, a wireless wide area network, a local area network, a metropolitan area network, a telephone network, and so forth.

The display 136 may include, but is not limited to, a liquid crystal display, a light-emitted diode display, an E-Ink™ display as made by E Ink Corp. of Cambridge, Mass., or any other similar type of output device. The display 136 may be used to show content to a user in the form of text, images, or video. In certain instances, the display 136 may also operate as a touch screen display that may enable the user to initiate commands or operations by touching the screen using certain finger or hand gestures.

The service provider server 118 may further comprise storage 138, such as removable storage and/or non-removable storage including, but not limited to, magnetic storage, optical disk storage, and/or tape storage. Storage 138 may provide non-transient storage of computer-executable instructions and other data. The storage 138 may include storage that is internal and/or external to the service provider server 118.

As previously mentioned, the memory 122 may store a routing module 128, a driver assignment module 130, and an efficiency module 132. In general terms, these various modules may communicate with each other and/or with the delivery station device 102 to manage delivery routes for a delivery station associated with the delivery station device 102. For instance, the routing module 128 may be configured to determine one or more delivery routes for a delivery station (e.g., a delivery station associated with the delivery station device 102). In certain implementations, the routing module 128 may determine the delivery routes in response to a routes request transmitted by the delivery station device 102 (e.g., from the delivery station module 110). In other implementations, the routing module 128 may be configured to periodically determine delivery routes according to a predetermined schedule (e.g., daily, weekly, monthly, and/or the like).

Furthermore, the routing module 128 may be configured to determine the delivery routes for the delivery station based at least in part on delivery demand information associated with the delivery station. For example, the delivery demand information may indicate a number of parcels to be delivered from the delivery station for a particular day. Additionally, the delivery demand information may also include location information indicating delivery locations for the parcels. In certain embodiments, the delivery routes may also be determined based at least in part on a number of available drivers for the day. Thus, in certain implementations, based on the factors mentioned above, the routing module 128 may determine and/or calculate relatively efficient delivery routes (e.g., relatively low route completion times).

The driver assignment module 130 may be configured to assign the determined delivery routes to one or more drivers. As such, the driver assignment module 130 may be configured to identify one or more available drivers for the delivery station for the day. In certain implementations, driver identifiers associated with available drivers may be provided to the driver assignment module 130 by the delivery station device 102 (e.g., via the delivery station module 110). In other implementations, the driver identifiers associated with the available identifiers may be stored in service provider datastore(s) 140. For example, the driver identifiers available to the delivery station may be indexed in the service provider datastore(s) 140 with a delivery station identifier associated with the delivery station.

Upon identifying the available drivers, the driver assignment module 130 may be configured to determine location history data associated with the drivers. Location history data may indicate, for respective drivers, past delivery locations driven to and/or visited by the respective drivers on past delivery routes. For instance, the location history data associated with a driver may be stored in the service provider datastore(s) 140 and may be indexed by the driver identifier associated with the driver. In certain implementations, the past delivery locations indicated by the location history data may include postal codes although other geographic information are also contemplated.

In addition to determining location history data associated with the drivers, the driver assignment module 130 may also be configured to determine route location data associated with the determined delivery routes. In other words, the driver assignment module 130 may determine one or more delivery locations covered by and/or otherwise associated with the delivery routes. As such, based at least in part on the location history data associated with the drivers and the route location data associated with the delivery routes, the driver assignment module 130 may determine respective route completion times for the drivers with respect to the delivery routes. For instance, in certain implementations, the driver assignment module 130 may estimate and/or calculate, for each driver, a route completion time for each driver to complete each delivery route. Such calculations may depend in part on the past delivery locations of the drivers indicated by their respective location history data.

For example, if a driver has previously driven to and/or visited a past delivery location, the driver assignment module 130 may estimate, for the driver, a faster route completion time associated with a delivery route that covers and/or includes the past delivery location than for a delivery route that does not cover and/or include the past delivery location. Thus, calculation of a driver's route completion time for a delivery route may be affected by whether the driver has previously driven to and/or visited a delivery location covered by the delivery route. In other words, the service provider server may determine that a driver will complete a route faster if he has previously driven to and/or visited a delivery location covered by the route.

Additionally, calculation of a driver's route completion time for a delivery route may also be based at least in part on how recently the driver has visited a past delivery location covered by the delivery route. The more recently a driver has driven and/or visited a past delivery location covered by the delivery route, the faster the driver's calculated route completion time for the delivery route. Furthermore, consider an example with a first delivery route and a second delivery route. The first delivery route may include a first past delivery location visited by the driver, and the second delivery route may include a second past delivery location visited by the driver. Additionally, the drive may have visited and/or driven to the first past delivery location more recently than the second past delivery location. Furthermore, under this example, if the driver had not previously visited any delivery locations covered by the first or second delivery routes, then the driver would have the same route completion time for both delivery routes. Under such a scenario, the driver assignment module 130 may be configured to determine a route completion time for the first delivery route, which may be less than a calculated route completion time for the second delivery route, due to the driver having visited the first past delivery location more recently than the second past delivery location.

According to some embodiments, upon determining the route completion times for the drivers with respect to the determined delivery routes, the driver assignment module 130 may be configured to generate a routing assignment schedule. The generated routing assignment schedule may assign the routes to the drivers based on a minimum total estimated route completion time. For instance, in certain implementations, the driver assignment module 130 may determine multiple routing assignment schedules, with different routing assignment schedules including different combinations of delivery routes and drivers. In addition, the driver assignment module 130 may calculate a total route completion time associated with each of the routing assignment schedules. The total route completion time for a routing assignment schedule may be the sum of the individual route completion times associated with the delivery route and driver combinations. To this end, the driver assignment module 130 may identify the routing assignment schedule associated with the lowest (e.g., fastest) total route completion time. For instance, driver assignment module 130 may successively compare respective total route completion times for each routing assignment schedule until the routing assignment schedule with the minimum total estimated route completion time is determined. In certain implementations upon identifying this routing assignment schedule, the driving assignment module 130 may be configured to transmit the routing assignment schedule to the delivery station device 102 and/or one or more driver devices 142.

According to certain embodiments, assignment of certain drivers to the delivery routes may be further based at least in part on efficiency data associated with the drivers. To this end, the efficiency module 132 may be configured to access or receive efficiency data associated with one or more of the identified drivers. In certain implementations, the efficiency data may be stored in the service provider datastore(s) 140 and indexed by driver identifiers associated with respective drivers. Furthermore, efficiency data associated with a driver may measure the ability of a driver to complete a typical route within a predetermined time period. For example, a typical route having an efficiency rating of 100% may include 150 parcels to be delivered within 10 hours. If a driver is able to only deliver 100 parcels in 10 hours, then the efficiency data of the driver may indicate the driver has a 67% efficiency. If the driver is able to deliver 200 parcels in 10 hours, then the efficiency data of the driver may indicate the driver has a 133% efficiency.

In view of the above, the efficiency module 132 may be configured to identify, for a driver, one or more delivery routes having efficiency ratings corresponding to efficiency data associated with the driver. For instance, using the example above, if a driver has a 67% efficiency, the efficiency module 132 may be configured to identify a route having a corresponding efficiency rating of 67%, e.g., a route associated with approximately 100 parcels (e.g., and/or within a predetermined range thereof) to be delivered in 10 hours based upon a typical route of 150 parcels to be delivered in 10 hours having an efficiency rating of 100%. The driver assignment module 130 may determine whether the driver is to be assigned any of the routes identified by the efficiency module 132 based at least in part upon efficiency data of the driver and efficiency ratings of the determined delivery routes.

In certain implementations, the operations associated with the efficiency module 132 may be performed on a subset of the drivers. For example, the driver assignment module 130 may direct the operations of the efficiency module 132 to be performed on drivers associated with efficiencies below a first efficiency threshold (e.g., new drivers and/or drivers unfamiliar with particular delivery locations). In other implementations, the driver assignment module 130 may direct the operations of the efficiency module 132 to be performed on drivers associated with efficiencies above a second efficiency threshold (e.g., relatively more efficient drivers may be assigned more difficult routes having a higher number of parcels to be delivered).

It will be further appreciated that while FIG. 1 illustrates the service provider server 118 as including various modules, in other embodiments, such modules may be dispersed among different servers and/or other devices in communication with each other. In other words, the service provider server 118 may be a collection of multiple servers that perform any combination of the functions of the modules illustrated in the service provider server 118.

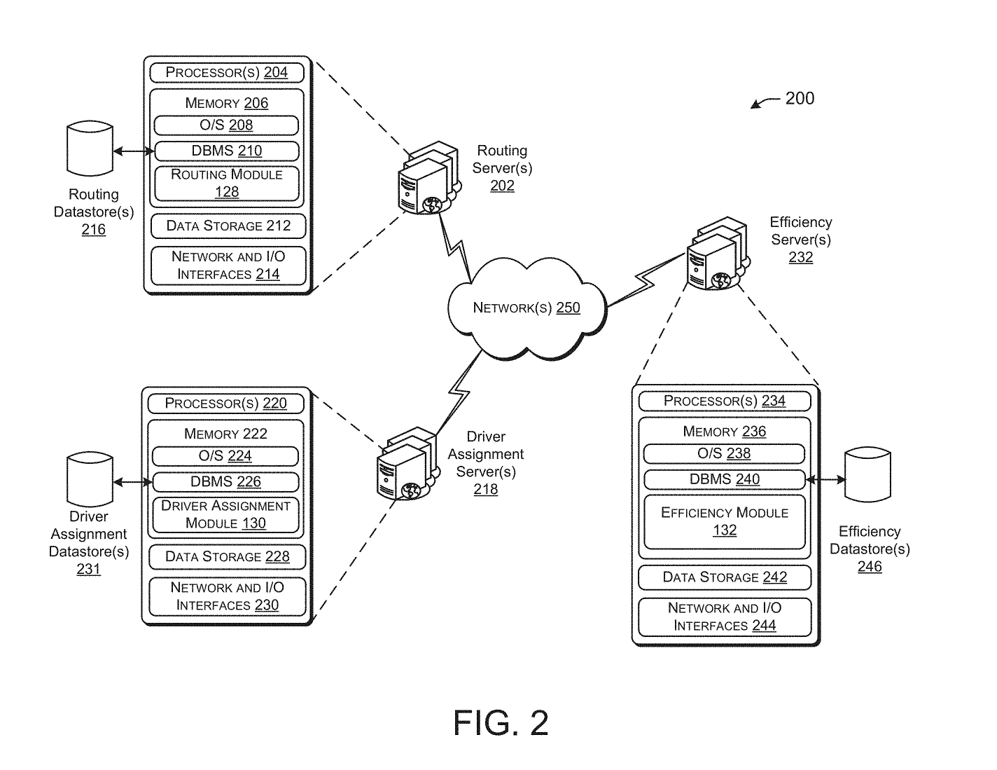

For example, FIG. 2 illustrates a system 200 that includes a routing server 202, a driver assignment server 218, and an efficiency server 232 in communication with each other through one or more networks 250. According to certain embodiments, these servers may collectively perform the functions described above with reference to the service provider server 118 of FIG. 1.

The routing server 202 may include one or more processors 204, one or more memory devices 206 (generically referred to herein as memory 206), data storage 212, and one or more network and I/O interface(s) 214. For ease of explanation, the routing server 202 will be referred to hereinafter in the singular. However, it should be appreciated that multiple routing servers 202 may be provided.

The processor(s) 204 may be configured to access the memory 206 and execute computer-executable instructions stored therein. For example, the processor(s) 204 may be configured to execute computer-executable instructions of the various program modules of the routing server 202 to cause or facilitate various operations to be performed in accordance with one or more embodiments of the disclosure. The processor(s) 204 may include any suitable processing unit capable of accepting digital data as input, processing the input data in accordance with stored computer-executable instructions, and generating output data. The processor(s) 204 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

The memory 206 may include volatile memory such as random access memory (RAM) and/or non-volatile memory such as read-only memory (ROM), flash memory, and so forth. In various implementations, the memory 206 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The memory 206 may store computer-executable instructions that are loadable and executable by the processor(s) 204, as well as data manipulated and/or generated by the processor(s) 204 during the execution of the computer-executable instructions. For example, the memory 206 may store one or more operating systems (O/S) 208; one or more database management systems (DBMS) 210; and one or more program modules, applications, or the like such as, for example, one or more routing module(s) 128. The various illustrative program modules depicted as being loaded into the memory 206 may include computer-executable instructions that, responsive to execution, may cause various processing to be performed. In order to perform such processing, the program modules may utilize various data stored in the memory 206, in the data storage 212, and/or in one or more external datastores, such as routing datastore(s) 216.

The (O/S) 208 loaded into the memory 206 may provide an interface between other application software executing on the routing server 202 and the hardware resources of the routing server 202. More specifically, the O/S 208 may include a set of computer-executable instructions for managing hardware resources of the routing server 202 and for providing common services to other application programs (e.g., managing memory allocation among various application programs). The O/S 208 may include any operating system now known or which may be developed in the future including, but not limited to, any server operating system, any mainframe operating system, or any other proprietary or freely available operating system.

It should be appreciated that any data and/or computer-executable instructions stored in the memory 206 may be additionally, or alternatively, stored in the data storage 212 and/or in one or more other datastores. The DBMS 210 depicted as being loaded into the memory 206 may support functionality for accessing, retrieving, storing, and/or manipulating data stored in external datastore(s) (e.g., the routing datastore(s) 216), data stored in the memory 206, and/or data stored in the data storage 212. For example, the DBMS 210 may be configured to retrieve user account data (e.g., inventory associated with the user account) from the routing datastores 216 responsive to receipt of the request from the routing server 202. The DBMS 210 may use any of a variety of database models (e.g., relational model, object model, etc.) and may support any of a variety of query languages.

As previously noted, the network and I/O interfaces 214 may also comprise one or more communication interfaces or network interface devices to provide for the transfer of data between the routing server 202 and another device (e.g., network server) via a network (not shown). The communication interfaces may include, but are not limited to, personal area networks (PANs), wired local area networks (LANs), wireless local area networks (WLANs), wireless wide area networks (WWANs), and so forth. The routing server 202 may be coupled to the network via a wired connection and/or a wireless connection. The communication interfaces may utilize acoustic, radio frequency, optical, or other signals to exchange data between the routing server 202 and another device such as an access point, a host computer, a server, a router, a reader device, and the like. The network may include, but is not limited to, the Internet, a private network, a virtual private network, a wireless wide area network, a local area network, a metropolitan area network, a telephone network, and so forth.

According to one or more example embodiments, computer-executable instructions provided as part of the routing module 128 may be configured to determine one or more delivery routes associated with a delivery station. As previously discussed, the delivery routes may be determined based on delivery demand information, delivery locations, and/or available drivers for the delivery station.

Referring now to other components of the system 200, the driver assignment server 218 may include one or more processors 220, one or more memory devices 222 (generically referred to herein as memory 222), data storage 228, and one or more network and I/O interface(s) 230. For ease of explanation, the driver assignment server 218 will be referred to hereinafter in the singular. However, it should be appreciated that multiple user driver assignment servers 218 may be provided.

The processor(s) 220 may be configured to access the memory 222 and execute computer-executable instructions stored therein. For example, the processor(s) 220 may be configured to execute computer-executable instructions of the various program modules of the driver assignment server 218 to cause or facilitate various operations to be performed in accordance with one or more embodiments of the disclosure. The processor(s) 220 may include any suitable processing unit capable of accepting digital data as input, processing the input data in accordance with stored computer-executable instructions, and generating output data. The processor(s) 220 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

The memory 222 may include volatile memory such as random access memory (RAM) and/or non-volatile memory such as read-only memory (ROM), flash memory, and so forth. In various implementations, the memory 222 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The memory 222 may store computer-executable instructions that are loadable and executable by the processor(s) 220, as well as data manipulated and/or generated by the processor(s) 220 during the execution of the computer-executable instructions. For example, the memory 222 may store one or more operating systems (O/S) 224; one or more database management systems (DBMS) 226; and one or more program modules, applications, or the like such as, for example, one or more driver assignment module(s) 130. The various illustrative program modules depicted as being loaded into the memory 222 may include computer-executable instructions that, responsive to execution, may cause various processing to be performed. In order to perform such processing, the program modules may utilize various data stored in the memory 222, in the data storage 228, and/or in one or more external datastores, such as driver assignment datastore(s) 231.

The O/S 224 loaded into the memory 222 may provide an interface between other application software executing on the driver assignment server 218 and the hardware resources of the driver assignment server 218. More specifically, the O/S 224 may include a set of computer-executable instructions for managing the hardware resources of the driver assignment server 218 and for providing common services to other application programs (e.g., managing memory allocation among various application programs). The O/S 224 may include any operating system now known or which may be developed in the future including, but not limited to, any server operating system, any mainframe operating system, or any other proprietary or freely available operating system.

It should be appreciated that any data and/or computer-executable instructions stored in the memory 222 may be additionally, or alternatively, stored in the data storage 228 and/or in one or more other datastores. The DBMS 226 depicted as being loaded into the memory 222 may support functionality for accessing, retrieving, storing, and/or manipulating data stored in external datastore(s) (e.g., the driver assignment datastore(s) 231), data stored in the memory 222, and/or data stored in the data storage 228. For example, the DBMS 226 may be configured to retrieve user account data (e.g., inventory associated with the user account) from driver assignment datastores 231 responsive to receipt of the request from the driver assignment server 218. The DBMS 226 may use any of a variety of database models (e.g., relational model, object model, etc.) and may support any of a variety of query languages.

As previously noted, the network and I/O interfaces 230 may also comprise one or more communication interfaces or network interface devices to provide for the transfer of data between the driver assignment server 218 and another device (e.g., network server) via a network (not shown). The communication interfaces may include, but are not limited to, personal area networks (PANs), wired local area networks (LANs), wireless local area networks (WLANs), wireless wide area networks (WWANs), and so forth. The driver assignment server 218 may be coupled to the network via a wired connection and/or a wireless connection. The communication interfaces may utilize acoustic, radio frequency, optical, or other signals to exchange data between the driver assignment server 218 and another device such as an access point, a host computer, a server, a router, a reader device, and the like. The network may include, but is not limited to, the Internet, a private network, a virtual private network, a wireless wide area network, a local area network, a metropolitan area network, a telephone network, and so forth.

According to one or more example embodiments, the computer-executable instructions provided as part of the driver assignment module 130 may be configured to generate a routing assignment schedule associated with identified drivers and determine delivery routes for a delivery station. As discussed above with reference to FIG. 1, the driver assignment module 130 may generate the routing assignment schedule based on various factors, including, but not limited to, location history data associated with the drivers, efficiency data, and/or route location data associated with the delivery routes.

Referring now to other components of the system 200, the efficiency server 232 may include one or more processors 234, one or more memory devices 236 (generically referred to herein as memory 236), data storage 242, and one or more network and I/O interface(s) 244. For ease of explanation, the efficiency server 232 will be referred to hereinafter in the singular. However, it should be appreciated that multiple user efficiency servers 232 may be provided.

The processor(s) 234 may be configured to access the memory 236 and execute computer-executable instructions stored therein. For example, the processor(s) 234 may be configured to execute computer-executable instructions of the various program modules of the efficiency server 232 to cause or facilitate various operations to be performed in accordance with one or more embodiments of the disclosure. The processor(s) 234 may include any suitable processing unit capable of accepting digital data as input, processing the input data in accordance with stored computer-executable instructions, and generating output data. The processor(s) 234 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

The memory 236 may include volatile memory such as random access memory (RAM) and/or non-volatile memory such as read-only memory (ROM), flash memory, and so forth. In various implementations, the memory 236 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth.

The memory 236 may store computer-executable instructions that are loadable and executable by the processor(s) 234, as well as data manipulated and/or generated by the processor(s) 234 during the execution of the computer-executable instructions. For example, the memory 236 may store one or more operating systems (O/S) 238; one or more database management systems (DBMS) 240; and one or more program modules, applications, or the like such as, for example, one or more efficiency module(s) 132. The various illustrative program modules depicted as being loaded into the memory 234 may include computer-executable instructions that, responsive to execution, may cause various processing to be performed. In order to perform such processing, the program modules may utilize various data stored in the memory 236, in the data storage 242, and/or in one or more external datastores, such as efficiency datastore(s) 246.

The O/S 238 loaded into the memory 236 may provide an interface between other application software executing on the efficiency server 232 and the hardware resources of the efficiency server 232. More specifically, the O/S 238 may include a set of computer-executable instructions for managing hardware resources of the efficiency server 232 and for providing common services to other application programs (e.g., managing memory allocation among various application programs). The O/S 238 may include any operating system now known or which may be developed in the future including, but not limited to, any server operating system, any mainframe operating system, or any other proprietary or freely available operating system.

It should be appreciated that any data and/or computer-executable instructions stored in the memory 236 may be additionally, or alternatively, stored in the data storage 242 and/or in one or more other datastores. The DBMS 240 depicted as being loaded into the memory 236 may support functionality for accessing, retrieving, storing, and/or manipulating data stored in external datastore(s) (e.g., the efficiency datastore(s) 246), data stored in the memory 236, and/or data stored in the data storage 242. For example, the DBMS 240 may be configured to retrieve user account data (e.g., efficiency data associated with one or more drivers) from efficiency datastores 246 responsive to receipt of the request from the efficiency server 232. The DBMS 240 may use any of a variety of database models (e.g., relational model, object model, etc.) and may support any of a variety of query languages.

As previously noted, the network and I/O interfaces 244 may also comprise one or more communication interfaces or network interface devices to provide for the transfer of data between the efficiency server 232 and another device (e.g., network server) via a network (not shown). The communication interfaces may include, but are not limited to, personal area networks (PANs), wired local area networks (LANs), wireless local area networks (WLANs), wireless wide area networks (WWANs), and so forth. The efficiency server 232 may be coupled to the network via a wired connection and/or a wireless connection. The communication interfaces may utilize acoustic, radio frequency, optical, or other signals to exchange data between the efficiency server 232 and another device such as an access point, a host computer, a server, a router, a reader device, and the like. The network may include, but is not limited to, the Internet, a private network, a virtual private network, a wireless wide area network, a local area network, a metropolitan area network, a telephone network, and so forth.

According to one or more example embodiments, computer-executable instructions provided as part of the efficiency module 132 may be configured to determine efficiency data associated with one or more drivers. As previously discussed, based at least in part on the efficiency data, the efficiency module 132 may be configured to identify one or more corresponding delivery routes.

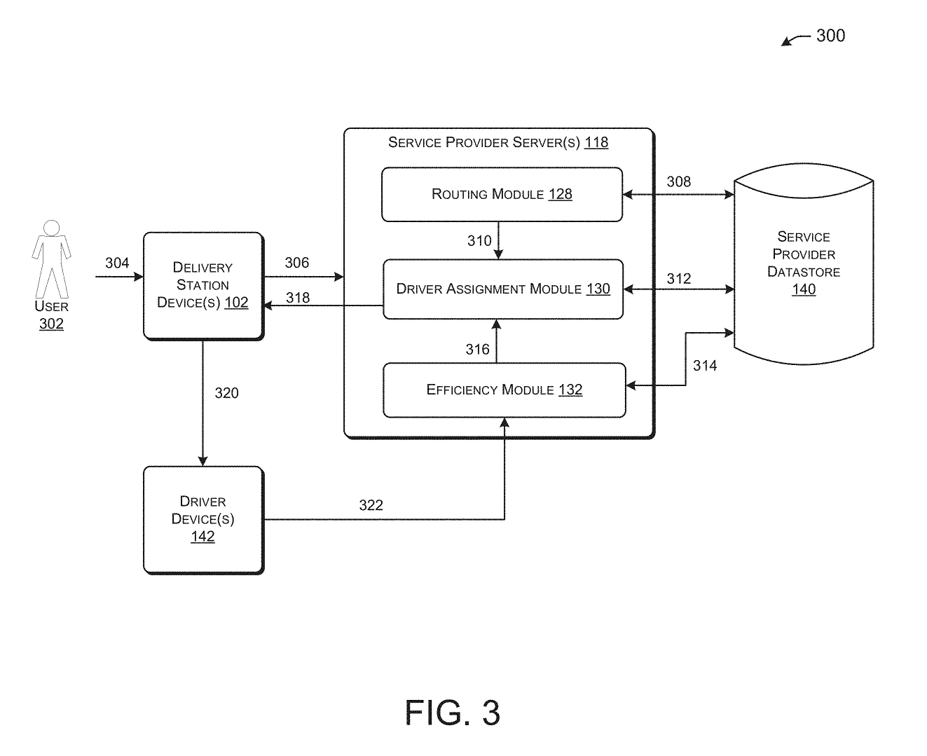

Referring now to FIG. 3, a block diagram of a data flow 300 for managing delivery routes is illustrated according to one or more example embodiments. According to the data flow 300, a user 302 may provide an indication 304 to the delivery station device 102 to determine a routing assignment schedule for the delivery station. For example, the user 302 may input a selection for a routing assignment schedule via a user interface provided by the delivery station device 102 (e.g., via the delivery station module 110). In certain implementations, the user 302 may also input one or more available drivers to be assigned routes as part of the indication 304.

The delivery station device 102 may transmit, to the service provider server(s) 118, a request 306 to determine the routing assignment schedules. In certain embodiments, the request 306 may also include driver identifiers associated with one or more available drivers for the delivery station. Upon receiving the request 306, the routing module 128 may be configured to access 308 the service provider datastore 140 to determine delivery demand information associated with the delivery station. For instance, the delivery station may be associated with a delivery station identifier, and the routing module 128 may use the delivery station identifier to identify the delivery demand information stored in the service provider datastore 140. Based at least in part on the delivery demand information, the routing module 128 may be configured to determine one or more routes for the delivery station. The routing module 128 may then provide the determined routes 310 to the driver assignment module 130.

Upon receipt of the determined routes 310, the driver assignment module 130 may be configured to access 312 the service provider datastore 140 to determine location history data associated with the drivers and route location data associated with the determined routes 310. To this end, the driver assignment module 130 may be configured to determine, based at least in part the location history data and the routing location data, respective route completion times associated with the drivers with respect to the determined routes. Based at least in part on the respective route completion times, the driver assignment module 130 may generate a routing assignment schedule associated with a lowest total route completion time. The driver assignment module 130 may then transmit 318 the routing assignment schedule to the delivery station device.

The delivery station device may then transmit 320 the routing assignment schedule to one or more driver devices 142. In some implementations, the entire routing assignment schedule for all drivers may be transmitted to the driver devices 142. On other implementations, only the routing assignment schedule assigned to a particular driver may be transmitted to the driver device 142 associated with the particular driver. Furthermore, in yet other implementations, the driver assignment module 130 may be configured to directly transmit the routing assignment schedule to the one or more driver devices 142.

Additionally, the one or more driver devices 142 may be configured to transmit 322 routing feedback data to the efficiency module 132. The routing feedback data may include, but is not limited to, delivery success data, delivery failure data, route completion time data, location data, parcel data, and/or the like. To this end, the efficiency module 132 may be configured to update, based at least in part on the routing feedback data, efficiency data associated with one or more drivers. For instance, delivery success data may indicate one or more stops along a route in which delivery was successful. Delivery failure data may indicate one or more stops along a route in which delivery was a failure or was unsuccessful. Route completion time data may indicate the total time the driver takes to complete a route. Furthermore, route completion time data may also indicate respective times spent by the driver for one or more stops along the route. Location data may indicate one or more locations visited by the driver along a route. Parcel data may indicate any data associated with one or more parcels along a route including, but not limited to, a total number of parcels, a number of parcels for each stop, type of parcels, parcel delivery instructions, and/or the like.

According to some embodiments, in generating the routing assignment schedule, the driver assignment module 130 may also consider efficiency data associated with one or more of the available drivers. To this end, the efficiency module 132 may be configured to access 314 the service provider datastore 140 to determine efficiency data associated with one or more of the available drivers. Based at least in part on the efficiency data, the efficiency module 132 may determine and/or identify one or more delivery routes corresponding to the efficiency data. The efficiency module 132 may transmit 316 the identified routes and their corresponding drivers to the driver assignment module 130. The driver assignment module 130 may then generate a routing assignment schedule such that the routing assignment schedule may be associated with lowest total route completion time in which the identified routes by the efficiency module 132 are assigned to their corresponding drivers.

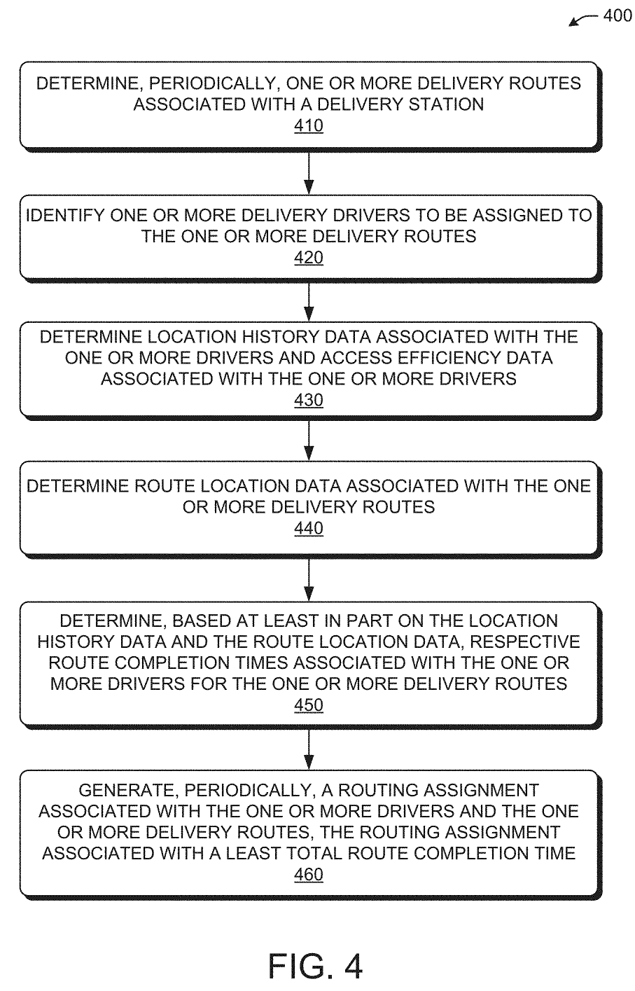

Referring now to FIG. 4, a flow diagram of a method 400 for managing delivery routes is illustrated according to one or more example embodiments. The method 400 may begin in block 410, where a service provider server 118 may determine one or more delivery routes associated with a delivery station. The determination of the delivery routes may be made periodically, e.g., monthly, weekly, daily, hourly, based upon shifts, or the like. In block 420, the service provider server may identify one or more delivery drivers to be assigned to the one or more delivery routes.

In block 430, the service provider server 118 may determine location history data associated with the one or more drivers and access or receive efficiency data associated with the one or more drivers. The location history data may indicate past delivery locations visited by the one or more drivers within a time period. In block 440 the service provider server 118 may determine route location data associated with the one or more delivery routes. The route location data may indicate locations to be covered by the one or more delivery routes. In block 450, the service provider server 118 may determine, based at least in part on the location history data and the route location data, respective route completion times associated with the one or more drivers for the one or more delivery routes. In block 460, the service provider server 118 may generate a routing assignment associated with the one or more drivers and the one or more delivery routes. The routing assignment may be associated with a minimum total estimated route completion time. Furthermore in some implementations, the routing assignment schedule may be generated based at least in part on the respective route completion times and the efficiency data associated with the one or more drivers.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1. A method, comprising:
identifying, by a service provider server, first sensor data received from a first delivery station device associated with a first driver of one or more delivery drivers to be assigned to one or more delivery routes, wherein the one or more delivery routes include a delivery location;
identifying, by the service provider server, second sensor data received from a second delivery station device associated with a second driver of one or more delivery drivers;
determining a first location history data associated with the first driver, wherein the first location history data is based at least in part on the first sensor data, and wherein the first location history data includes the delivery location and a first delivery time at the delivery location;
determining a second location history data associated with the second driver, wherein the second location history data is based at least in part on the second sensor data, and wherein the second location history data includes the delivery location and a second delivery time at the delivery location;
determining the first delivery time is more recent than the second delivery time;
determining route location data associated with the one or more delivery routes, the route location data indicating locations to be covered by the one or more delivery routes;
determining, based at least in part on the location history data and the route location data, respective estimated route completion times associated with the one or more delivery drivers and the one or more delivery routes;
receiving efficiency data associated with the one or more delivery drivers; and
generating, periodically based at least in part on the respective estimated route completion times, the determination the first delivery time is more recent than the second delivery time, and the efficiency data, a routing assignment schedule associated with the one or more delivery drivers and the one or more delivery routes, the routing assignment schedule associated with a minimum total estimated route completion time, wherein the routing assignment schedule includes an assignment of a first delivery route of the one or more routes to the first driver, wherein the first delivery route includes the delivery location.

2. The method of claim 1, wherein determining the respective estimated route completion times further comprises:
determining, based at least in part on the first location history data, that the first delivery driver of the one or more delivery drivers has previously visited a first delivery location more recently than a second delivery location; and
identifying, from the one or more delivery routes, a first delivery route and a second delivery route, wherein the first delivery route covers the first delivery location and the second delivery route covers the second delivery location.

3. The method of claim 2, further comprising:
determining, for the first delivery driver, a first estimated route completion time associated with the first delivery route and a second estimated route completion time associated with the second delivery route, wherein the first estimated route completion time is less than the second estimated route completion time.

4. The method of claim 1, further comprising:
transmitting the routing assignment schedule to a delivery station device or to a delivery driver device.

5. The method of claim 1, wherein generating the routing assignment schedule further comprises:
determining a first total estimated route completion time associated with the routing assignment schedule;
determining a second total estimated route completion time associated with a second routing assignment schedule;
determining that the first total estimated route completion time is less than the second total estimated route completion time;
identifying the first total estimated route completion time as the minimum total estimated route completion time; and
generating the routing assignment schedule for a delivery station.

6. A system, comprising:
at least one processor;
at least one memory storing computer-executable instructions, that when executed by the at least one processor, causes the at least one processor to:
identify first sensor data received from a first delivery station device associated with a first delivery driver to be assigned to one or more delivery routes, wherein the one or more delivery routes include a delivery location;
identify second sensor data received from a second delivery station device associated with a second driver;
determine a first location history data associated with the first delivery driver, wherein the first location history data is based at least in part on the first sensor data, and wherein the first location history data includes the delivery location and a first delivery time at the delivery location;
determined a second location history data associated with the second driver, wherein the second location history data is based at least in part on the second sensor data, and wherein the second location history data includes the delivery location and a second delivery time at the delivery location;
determine the first delivery time is more recent than the second delivery time;
determine route location data associated with the one or more delivery routes;
receive efficiency data associated with the first delivery driver; and
assign, based at least in part on the location history data, the route location data, the determination the first delivery time is more recent than the second delivery time, and the efficiency data, a first delivery route of the one or more delivery routes to the first delivery driver, wherein the first delivery route include the delivery location.

7. The system of claim 6, wherein the computer-executable instructions to assign the first delivery route further comprises instructions to:
determine, based at least in part on the first location history data, that a first past delivery location has been more recently visited by the first delivery driver than a second past delivery location; and
determine, based at least in part on the route location data, that the first delivery route is associated with the first past delivery location and a second delivery route is associated with the second past delivery location.

8. The system of claim 7, wherein the computer-executable instructions further cause the at least one processor to:
determine, for the first delivery driver, a first estimated route completion time associated with the first delivery route and a second estimated route completion time associated with the second delivery route, wherein the first estimated route completion time is less than the second estimated route completion time; and
assign the first delivery route to the first delivery driver based at least in part on the first estimated route completion time being less than the second estimated route completion time.

9. The system of claim 6, wherein the computer-executable instructions to determine the one or more delivery routes further comprise instructions to:
determine the one or more delivery routes based at least in part on a number of parcels to be delivered from a delivery station for a day.

10. The system of claim 6, further comprising computer-executable instructions that cause the at least one processor to:
receive, from a delivery driver device associated with the first delivery driver, route feedback data associated with the first delivery driver and one or more assigned delivery routes.

11. The system of claim 10, wherein the route feedback data comprises at least one of delivery success data, delivery failure data, actual route completion time data, location data, or parcel data.

12. The system of claim 6, wherein the efficiency data comprises information associated with at least one of a parcel delivery rate, a delivery success rate, a delivery time, a delivery location, experience level, or tenure.

13. The system of claim 6, wherein the computer-executable instructions to assign the first delivery route further comprises instructions to:
assign the first delivery route of the one or more delivery routes to the first delivery driver based upon a correspondence between the efficiency data of the first delivery driver and an efficiency rating of the first delivery route.

14. The system of claim 13, wherein the computer-executable instructions to assign the first delivery route further comprises instructions to:
assign the first delivery route of the one or more delivery routes to the first delivery driver based upon the correspondence between the efficiency data of the first delivery driver and the efficiency rating of the first delivery route in response to the efficiency data of the first delivery driver being one of less than a first efficiency threshold or greater than a second efficiency threshold.

15. A non-transitory computer readable medium comprising instructions that when executed by at least one processor, cause the at least one processor to:
identify first sensor data received from a first delivery station device associated with a first delivery driver to be assigned to one or more delivery routes, wherein the one or more delivery routes include a delivery location;
identify second sensor data received from a second delivery station device associated with a second driver determine location history data associated with the first delivery driver and a second delivery driver, the location history data including a delivery location;
determine a first route location data associated with the driver, wherein the first route location data is based at least in part on the first sensor data, and wherein the first route location data includes the delivery location and a first delivery time at the delivery location;
determine a second route location data associated with the second driver, wherein the second route location data is based at least in part on the second sensor data, and wherein the second route location data includes the delivery location and a second delivery time at the delivery location;
determine the first delivery time is more recent than the second delivery time;
receive efficiency data associated with the first delivery driver; and
assign, periodically based at least in part on the location history data, the route location data, the determination the first delivery time is more recent than the second delivery time, and the efficiency data, a first delivery route of the one or more delivery routes to the first delivery driver.

16. The computer readable medium of claim 15, wherein the computer-executable instructions to assign the first delivery route further comprises instructions to:
determine, based at least in part on the first route location data, that the first delivery route is associated with the first past delivery location and a second delivery route is associated with the second past delivery location.

17. The computer readable medium of claim 16, wherein the computer-executable instructions further cause the at least one processor to:
determine, for the first delivery driver, a first estimated route completion time associated with the first delivery route and a second estimated route completion time associated with the second delivery route, wherein the first estimated route completion time is less than the second estimated route completion time.

18. The computer readable medium of claim 17, wherein the computer-executable instructions to assign the first delivery route further comprises instructions to:
assign the first delivery route to the first delivery driver based at least in part on the first estimated route completion time being less than the second estimated route completion time.

19. The computer readable medium of claim 15, wherein the computer-executable instructions further cause the at least one processor to:
transmit, to a delivery driver device associated with the first delivery driver or a delivery station device, the first delivery route.

20. The computer readable medium of claim 15, further comprising computer-executable instructions that cause the at least one processor to:
receive, from a delivery driver device associated with the first delivery driver, route feedback data associated with the first delivery driver and one or more assigned delivery routes.
